(19) United States
(12) Patent Application Publication
(10) Pub. No.: US 2008/0141652 A1
(43) Pub. Date: Jun. 19, 2008

(54) Ring jet propulsor

(76) Inventor: Bereli M. Lazar, San Francisco, CA (US)

Correspondence Address: Bereli M. LAZAR, Apt. 410s, 1590 Broadway St., San Francisco, CA, 94109, US

(21) Appl. No.: 11/581,271

(22) Filed: Oct. 16, 2006

(51) Int. Cl. B64G 1/40

(52) U.S. Cl. 60/204

(57) ABSTRACT

A ring jet propulsor for various motor vehicles, using non-fuel fluid propellants which can be ambient like water and/or air, or stored aboard, includes:
a circle tubular tunnel having inside and axial-flow impeller cyclically driving said propellants;
intake and outlet sealing rotary impellers,
auxiliary devices, meters, control;
an effective source of power, like turboset-self-booster.
   The axial-flow impeller works at itself, for itself, in actual series with itself, thus providing pressure rising and constant operative energy self-accumulation. The ring jet propulsor can be used in multiple applications with any kind of accelerators and/or independently, forming an effective family of jet motor structures, including water jet propeller motors for ships or boats, and combined fluid dynamic versions of jet motors for air crafts. With propulsors' pressure ratio from 7.5 to 10.5 the averaged jet thrust is about 280% of conventional the same-power-jet-engines.

### CROSS-REFERENCE TO RELATED APPLICATIONS

Not applicable.

### FEDERALLY SPONSORED RESEARCH

Not applicable.

### SEQUENCE LISTING OR PROGRAM

Not applicable.

### BACKGROUND OF THE INVENTION

This proposal relates to fluid dynamic jet propulsion structures for motor vehicles. It also relates to jet motors working with nonfuel, noncombustible fluid propellants. The general idea and technological approach are similar to some test wind and water tunnels with their well-known high energy ratios, which never were used as a source of power.

The philosophical principle of this proposal is near to U.S. patent application Ser. No. 11/399,661 entitled “Hydrodynamic closed loop turboset-self-booster” and filed on Apr. 7, 2006 in the U.S. Patent Office. Said turboset, developed by present author, is a universal power unit based on self-accumulating technology of constant operative liquid, which drives bispindle turbines-turbogenerators (FIG. 7). The general technological approach of said turboset can be considered as a prior art-idea to the present proposal.

In the current proposal the self-accumulating fluid-dynamic ring technology is developed for jet motors and their propulsion subunits in various versions for jet-propelled vehicles, including rockets.

Other prior arts directly related to “ring jet propulsor,” as a motor based on cyclically self-amplifying fluid dynamic propellant in a circled circuit, were not found.

### BRIEF SUMMARY OF THE INVENTION

This proposal developed for jet motor vehicles using gaseous and/or liquid nonfuel, noncombustible propellants includes:
A ring tubular tunnel, having inside an axial flow impeller cyclically driving said propellants,
Intake and outlet sealing impellers,
Auxiliary devices, meters, and control. Said axial-flow impeller works in the ring tunnel at itself, for itself in actual series with itself. The fluid pressure inside the tunnel raises providing constant operative energy accumulation and high efficiency with ratio from 7.5 to 10.5.

The ring jet propulsor can be used independently and/or in multiple design applications with any kind of nonfuel accelerators forming an effective family of jet motor structures without conventional combustibles. The liquid and gaseous propellants can be used simultaneously working for a common united and combined acceleration structure of jet motors when needed by design. The said fluid propellants can be ambient like water or air, and/or stored aboard vehicles.

The ring jet propulsor can provide real effectiveness of water jet propeller motors for boats and ships in order to replace the conventional low-speed and low-efficient mechanical screw propellers as obviously outdated. The ring jet propulsor can provide real substantial increase of jet motors' thrust forces with effectively reducing their energy requirements due to self-accumulation technology developed.

### DRAWING FIGURES

The drawings are schematic and simplified for better clarity of solutions developed. In the drawings, closely related units and elements have the same numbers but different alphabetic suffixes.

FIG. 1 shows a side view-vertical section of a ring jet propulsor for gaseous propellants.

FIG. 2 illustrates a plan view-partial section 2-2 taking in FIG. 1.

FIG. 3 shows a side view-vertical section of a ring jet propulsor for liquid propellants; note to FIG. 3, marked

[symbol]

FIG. 4 illustrates a side view of an example of aggregated gasodynamic ring jet motor structure.

FIG. 5 shows a side view of an example of aggregated hydrodynamic ring jet motor structure.

FIG. 6 illustrates a plan view-horizontal section of a combined aggregated motor structure including united hydrodynamic and gasodynamic ring jet motors working for common jets' accelerator.

FIG. 7 shows a hydrodynamic closed loop turboset-self-booster with its electric generators; this unit is a preferable power unit and a philosophical prior art to present proposal, an idea approach.

FIG. 8 illustrates a plan view of two hydrodynamic ring jet propulsors forming a common ambient water jet propeller system for an example ship.

FIG. 9 shows a plan view of two combined motor structures each including united hydrodynamic and gasodynamic ring jet motor as a thrust engine for an example aircraft of future designs.

### REFERENCE NUMERALS AND SYMBOLS IN DRAWINGS

This proposal includes a family of general fluid dynamic versions of ring jet propulsors, their units, assemblies, and arrangements, including various kinds of propellants.

a) gaseous propellant jet propulsors:

| | | | |
|---|---|---|---|
| 20 | oval jet propulsor, | 21 | tubular oval tunnel, |
| 22 | axial flow gas compressor, | 23 | intake rotary seal compressor |
| 24 | outlet rotary seal compressor, | 25 | noise absorber system. |

b) liquid propellant jet propulsors:

| | | | |
|---|---|---|---|
| 30 | circle jet propulsor, | 31 | tubular circle tunnel, |
| 32 | axial flow propeller pump, | 33 | intake rotary seal pump, |
| 34 | outlet rotary seal pump, | 35 | liquid flow equalizer, |
| 36 | piston-valve cavitation blocker, | 37 | outlet unit, |
| 37R | outlet reverse unit, | 38 | bypass adjuster. |

c) fluid dynamic ring jet motor structures:

| | |
|---|---|
| 40 | gasodynamic oval jet motor, |
| 41 | gas container unit, |
| 41F | gas pressure reducer-feeder, |
| 42 | discharge gas accelerator unit, |
| 50 | hydrodynamic circle jet motor, |
| 50A | ambient propellant hydrodynamic circle jet motor, |
| 51 | liquid propellant tank, |
| 51F | liquid propellant feeder, |
| 52 | discharge liquid accelerator unit, |
| 60 | combined fluid dynamic ring jet motor, |
| 61 | common united discharge accelerator. |

d) prior art and ring jet propulsor examplary usage:

| | |
|---|---|
| 70 | hydrodynamic closed loop turboset-self-booster, |
| 71 | bispindle coaxial turbine, |
| 72 | axial flow propeller pump, |
| 73 | electric generator (or alternator). |

e) universal units:

| | | | |
|---|---|---|---|
| 80 | vane, | 81 | filter, |
| 82 | nozzle, | 83 | impeller drive unit, |
| 84 | meters, | 85 | control, |
| 90 | examplary ship, | 91 | examplary aircraft. |

Symbols:
[symbol] gas propellant inlet,
[symbol] gas oval flow,
[symbol] gas propellant discharge, [symbol] liquid propellant inlet, [symbol] liquid circle flow, [symbol] liquid propellant discharge, [symbol] combined propellant discharge, [symbol] constant hydroflow, [symbol] technological connections. Reference numbers 80, 81, 82, and the regular infrastructure of units including frames, valves, some filters, other obvious devices are conventional and are not shown in schematic drawings in some figures related to present proposal.

### DETAILED DESCRIPTION OF THE INVENTION

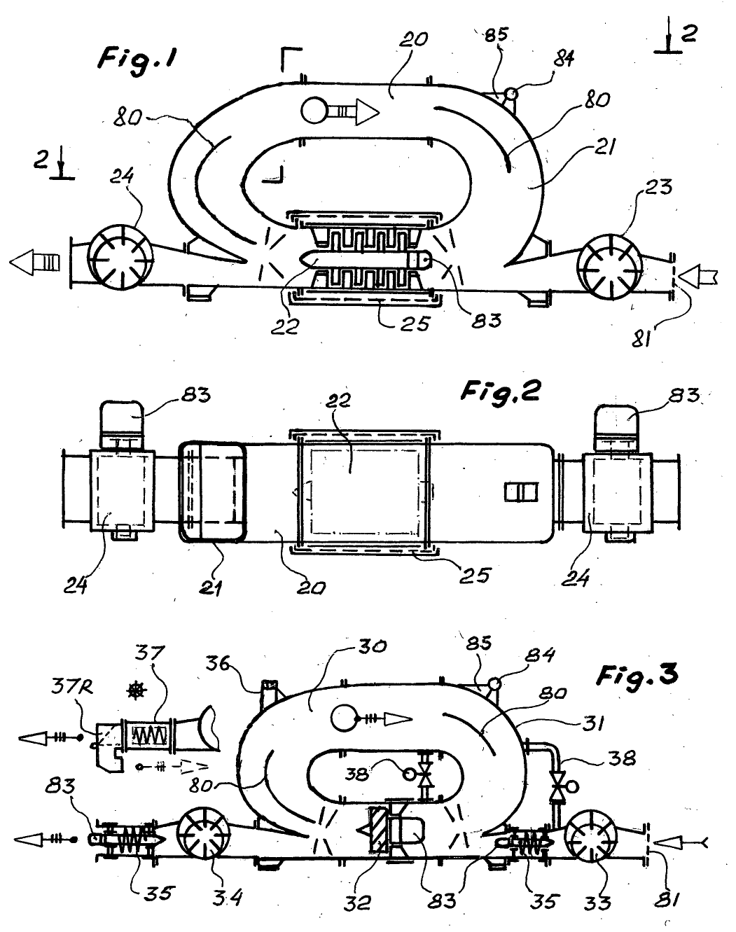

The fluid dynamic ring jet propulsor is represented in several general arrangements and applications related to usage of nonfuel, noncombustible fluid propellants in jet-driven vehicles.
A. Drawing FIGS. 1 to 9 illustrate the preferable embodiments of the present proposal developed for gaseous, liquid, and combined fluid propellants in various motor structures. The recommended power source and examplary applications are also shown.

FIGS. 1, 2 illustrate a gasodynamic version of the system proposed, an oval jet propulsor 20 including:
A tubular oval tunnel 21,
An axial-flow gas compressor 22,
A gas intake rotary sealing sliding vane compressor 23,
An outlet rotary seal compressor 24,
A noise absorber system 25,
Drive units 80, meters 81, devices of control 82.
   FIG. 3 shows a liquid dynamic version of the system proposed, a circle jet propulsor 30 including:
A tubular circle tunnel 31,
An axial-flow propeller pump 32,
An intake seal vane rotary pump 33,
An outlet seal vane rotary pump 34,
Liquid flow equalizers 35, a helical device;
A piston-valve cavitation blocker 36,
An outlet unit 37,
Bypasses-adjusters 38,
Drive units 80,
Meters 81,
Control devices 82.
   Said propulsor 30 can be used as an ambient water jet propeller for boats and ships; in this case said outlet unit 37 includes a reverse unit 37R; said flow equalizers 35 are preferably varying pitch helical rotary pumps. Said cavitation blocker 36 is a piston-springed regulating device.

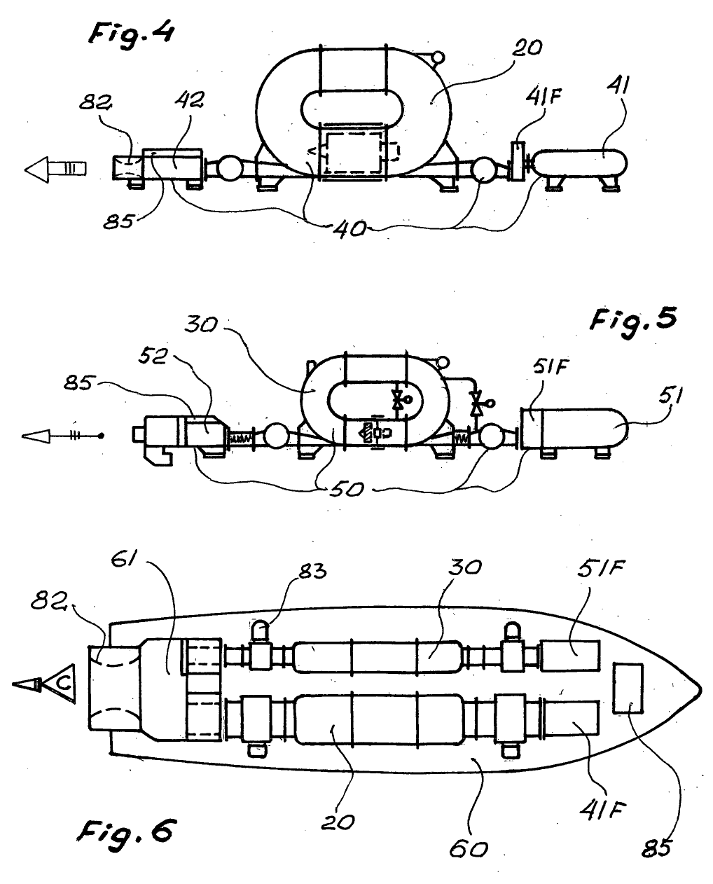

FIG. 4 illustrates a gasodynamic oval jet motor 40, comprising an oval jet propulsor 20, gas-container unit 41, gas pressure reducer-feeder 41F, discharge gas accelerator unit 42. The gas propellant discharge from nozzle 82 is also shown.

FIG. 5 shows a liquid dynamic circle jet motor 50, comprising a circle jet propulsor 30, liquid propellant tank 51, liquid propellant feeder 51F, discharge liquid accelerator unit 52 with outlet reverse unit 37R.

FIG. 6 illustrates a combined fluid dynamic ring jet motor 60, comprising a gasodynamic oval jet propulsor 20, liquid dynamic circle jet propulsor 30, both connected to common united discharge accelerator 61. The liquid and gaseous propellant feeders 51F and 41F respectively, nozzle 82, drive units 83, control 85 are also shown.

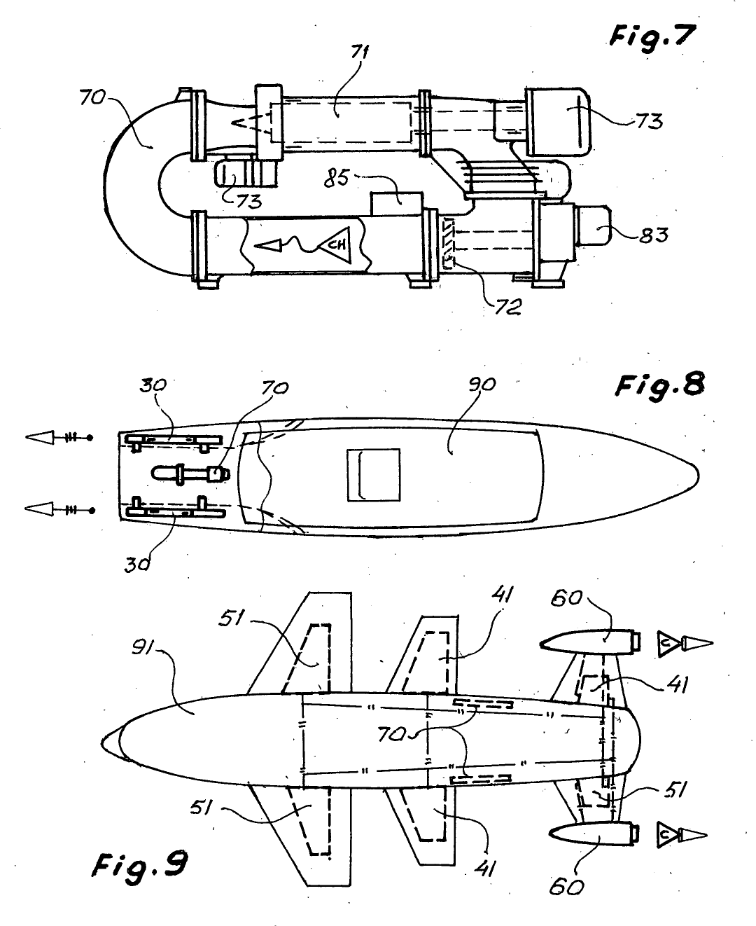

FIG. 7 shows the “hydrodynamic closed loop turboset-self-booster” 70 as a philosophical prior art to present proposal. Said turboset-self-booster is a universal turbogenerator based on self-accumulating closed circuit with a bispindle coaxial hydroturbine 71 working in constant operative liquid flow driven by propeller pump 72. Said turbine 71 drives electric generators 73 forming an effective source of power preferable for present proposal. The general idea of turboset's 70 self-accumulating technology is similar to ring-accumulating method of present proposal by principal technological approaches.

FIG. 8 illustrates an examplary usage of two liquid dynamic circle jet propulsors 30 for an exemplary ship 90. Both said propulsors 30 work as high efficient self-accumulating water jet-propellers powered by common said turboset-self-booster 70 as a source of energy.

FIG. 9 illustrates an examplary usage of two combined fluid dynamic ring jet motors 60 into an examplary future-design arrangement aircraft 91. The liquid propellant tanks 51 and compressed gas propellant containers 41, technologically connected to said motors 60 are also shown.

### B. Operation and General Interactions.

a) The intake slide-vane impeller 23 or 33 feeds the fluid propellant into its tunnel 21 or 31 respectively.

b) The axial flow impeller 22 or 32 works in actual series with itself, at itself, and for itself cyclically raising the propellant pressure inside the tunnels in about 7.5 to 10.5 times, accumulating the energy of ring-moving propellant and forming high potential propellant flow in the tunnels 21 or 31 after definite numbers of circular cycles up to stable regime.

c) The outlet impeller 24 or 34 feeds the high-pressure propellant from said tunnel 21 or 31 to accelerator 42 or 52 providing additional pressure to the flow,

d) Said intake impeller 23 or 33 continues to feed said tunnel 21 or 31, which continues its dynamic pressure accumulation, mixing new feed-up propellant from impeller 23 or 33 with high-pressure circular flow inside said tunnel 21 or 31 and feeding said outlet impeller 24 or 34 respectively.

e) The sealing of ring tunnels with their high potential, dynamically self-accumulating flows is provided by sliding-vane rotary impellers of inlet and outlet units.

f) In case of liquid propellants the smoothing and pressure-rate regulations to the fluid-flow is provided by adjustable bypasses 38 and flow equalizers 35; the springed piston-valve 36 limits possible cavitation, prevents vibrations, provides smooth interactions among all fluid-connected units.

g) In case of ambient water jet propulsor for ships and boats the pressure of propellant, discharged by outlet impeller, is the working pressure of the thrust force to the vehicle.

h) In case of combined propellant version the aggregated fluid-jet pressure provides the total united thrust force to the vehicle.

i) The method includes built-in noise absorbers, inlet filters, ejecting nozzles, and needed meters for adjusting and control.

### C. Some Basic Data and Formulae:

Ring jet propulsor output power ratio Rⱼₚ;

$${R}_{jp} = {C}_{u} \times \frac{{W}_{j}}{\sum } \frac{d}{{W}_{m}}$$

where
output power of discharge-jets after outlet impellers,
sum power of all impellers' drives,
units' transfer coefficient;

where

Qjd—jet discharge propellant flow capacity, m²/ₛ or gal/min
—sum of impellers' and self-accumulated tunnels' pressure, P.S.I.

where

pressure of discharge impeller,
Pt—accumulated pressure of propellant in tunnel,
Rt—tunnels impeller pressure ratio,
—common total fluid dynamic efficiency.
=

$${R}_{j . p .} = {C}_{u} \times \frac{{Q}_{jd} \times ΣΔ P \times η}{Σ {W}_{m}} = 7.5 \text{to} 10.5 , \text{averaged} .$$

Some versions of thrust for various exemplary jet motor systems:
a) Thrust of ambient propellant water jet motor Tₐⱼᵣ, kg or lb;

where
Sn—area of discharge nozzle; K-design coefficient.
b) Thrust of an exemplary electric propulsion jet motor system with ring jet propulsor as a sub-unit Tej is a vector sum:

Tea—electric accelerators' thrust for various electrothermal, magneto plasma dynamic, ion electric propulsion structures; b—design constant;
I—total current conducted through plasma;
   Tjp—ring jet propulsor thrust: T̅ᵣⱼₚ=Δ p̅.sn
c) Thrust of an examplary combined ring jet motor Tc.m. which is a vector sum of liquid propulsor's trust T_{l.p}; gas propulsor's thrust Tgp; accelerator propulsion thrust Tap, accounting coefficients of interactions, depending on design particularities, K1 and K2:

What is claimed is:

1. A ring jet propulsor for motor vehicles, comprises:
a. a ring tubular tunnel including placed inside an axial flow fluid-propellant impeller, and
b. a fluid-intake sealing rotary impeller unit, and
c. a fluid-outlet sealing rotary impeller unit.

2. The ring jet propulsor of claim 1, designed for work with gaseous propellants, includes:
an axial flow gas compressor placed inside a gasodynamic oval tubular tunnel, and
sealing, preferably sliding-vane gas compressors for intake and outlet impeller units.

3. The ring jet propulsor of claim 1, designed for work with liquid propellants, includes:
an axial flow propeller pump, placed inside a hydrodynamic circle tubular tunnel, and
sealing, preferably sliding-vane rotary pumps with preferably helical rotary flow-equalizers for intake and outlet impeller units.

4. The ring jet propulsor for liquid propellants of claim 3 wherein said circle tubular tunnel comprises:
a springed piston-valve cavitation blocker, and
hydrolic bypasses-adjusters.

5. The ring jet propulsor of claim 1 can be designed for usage of:
ambient propellants like water and air,
fluid propellants stored aboard of vehicle, and
any kind of combined propellants said above, and working in common united structure.

6. The ring jet propulsor of claim 1 wherein said axial flow fluid impeller drives the propellant cyclically, working in said ring tubular tunnel at itself, for itself, in actual series with itself, thus providing:
pressure rising and energy accumulation by self-amplifying up to designed level,
forming in said tunnel a constant high potential fluid pressure discharge jet from the tunnel-propellant flow, after said outlet impeller, for vehicle's total powerful thrust.

7. The ring jet propulsor of claim 6 wherein said axial flow impeller and impellers of intake and outlet units are adjustable by flow rate regulations.

8. A method of ring jet propulsors for motor vehicles comprising energy self-accumulating round operation of fluid propellants driven by rotary impellers inside circular tunnels thus producing high pressure ratio discharge jets of said propellants for:
a. Independent work of said propulsors as jet propellers, and/or
b. Combined work of said propulsors as operative units arranged with any kind of fluid-propellant accelerators forming united ring jet motor structures.

9. The method of claim 8 wherein said fluid accelerators, fed by high potential flow from ring jet propulsors, can be any of non-fuel and non-combustible, fluid-propulsion systems including electric, electrothermal, magnetoplasma dynamic, chemical, hybrids.

10. The method of claim 8 wherein said ring jet motor structures include a moveable gate for jet redirecting when reverse thrust is required by design.

11. The method of claim 8 wherein the power requirements of said ring jet motor structures can be provided by “Hydrodynamic closed loop turboset-self-booster” of U.S. patent application Ser. No. 11/399,661 as an effective energy source for all impellers, drives, and other devices including fluid accelerators.

12. The method of claim 8 can be used in rocket systems based on liquid and/or gaseous non-fuel, non-combustible propellants.

13. The method of claim 8 wherein said jet motor structures can comprise built-in noise absorbers.

14. The method of claim 8 wherein said jet motor structures include fluid dynamic vanes, protecting inlet filters, ejecting nozzles, and a system of meters for control.
